(19) United States
(12) Patent Application Publication
(10) Pub. No.: US 2017/0191235 A1
(43) Pub. Date: Jul. 6, 2017

(54) Pet Waste Collection System

(71) Applicant: Damien Bean, Torrance, CA (US)

(72) Inventor: Damien Bean, Torrance, CA (US)

(21) Appl. No.: 15/339,904

(22) Filed: Oct. 31, 2016

Related U.S. Application Data
(60) Provisional application No. 62/248,654, filed on Oct. 30, 2015.

(51) Int. Cl. E01H 1/12; B25J 1/04; A01K 23/00

(52) U.S. Cl. CPC E01H 1/1206; A01K 23/005; B25J 1/04; E01H 2001/1226; E01H 2001/1266; E01H 2001/1286

(57) ABSTRACT

A pet waste collection device for collecting and discarding pet waste. The device comprises an extendable support pole comprising a first pole portion and a second pole portion, each having a first end and a second end. The first end of the second pole portion is slidably receivable within the second end of the first pole portion A securing mechanism releasably secures the first pole portion relative to the second pole portion. A spring-biased catching component is mounted to the second end of the second pole portion. A spring-biased switch mechanism is located at the first end of the first pole portion. A cable connects the catching component to the switch mechanism. Upon pulling the switch mechanism in a general direction away from the catching component, the catching component closes. Upon releasing the switch mechanism, the switch mechanism biases back toward the catching component and the catching component biases back to an open position.

### CLAIM OF PRIORITY

This patent application claims priority under 35 USC 119 (e) (1) from U.S. Provisional Patent Application Ser. No. 62/248,654 filed Oct. 30, 2015, of common inventorship herewith entitled, “Ultimate Dog Walker,” which is incorporated herein by reference as though the same were set forth in its entirety.

### FIELD OF THE INVENTION

The present invention pertains to the field of pet accessories, and more specifically to the field of pet waste collection devices.

### BACKGROUND OF THE INVENTION

Dogs provide unconditional love, companionship and unmatched loyalty to their human owners. Known as man's best friend, dogs offer protection and are faithful and constant friends. Although a dog is a delightful addition to any family, cleaning up after them is unpleasant at best. Collecting and disposing of their pet's fecal matter is a disagreeable task yet most conscientious dog owners realize it must be done. Pet owners who live in cities and suburban areas are required by laws and local ordinances to remove dog waste from sidewalks and lawns immediately after the animal has answered the call of nature. For those owners who live in less populated areas, removing pet waste is a key factor in maintaining an attractive and dean yard.

Many pet owners collect their dog's waste in either a plastic bag or tissue. Other owners collect dog waste through use of a pet scooper. Scoopers offer a hands free means of picking up after one's pet, but their handles are short and their use requires a person to stoop to the ground in to retrieve the waste. For those with physical limitations such as back or knee problems, bending or stooping over to clean up after an animal causes pain and discomfort. And once waste is collected within the scooper, the user is faced with a challenge of emptying the scooper of its contents, usually an unhygienic and unsettling endeavor.

The prior art has put forth several designs for pet waste collection devices. Among these are:

U.S. Pat. No. 7,744,136 to Randall C. Waltz describes a remote collection and bagging device for a sanitary and convenient means for collecting and disposing of refuse or fecal matter at a distance from a user. The device comprises a handle and trigger, a foldable extension shaft, a cable attached to the trigger and slide bars, the slide bars also connected to a set of claws which are spring biased in a normally open position and a bag retention mechanism. The claws have teeth that intermesh with each other when in a closed position such that the teeth extend past each other in order to get beneath the refuse or material being collected. Once refuse is collected, the device is raised to a horizontal position thereby causing the collected material to fall into the attached bag for easy disposal.

U.S. Pat. No. 7,686,361 to Douglas G. Flinn describes an animal waste handling device includes an elongated foldable. A hand hold thereon has a trigger that operates against a spring bias. A clamp including an upper and a lower clamp element is provided on the handle. A sliding housing is provided on the handle adjacent to the clamp elements and the clamp elements are pivotally attached to the sliding housing. The sliding housing is moved against a spring bias. When the trigger in the hand hold is operated, a cable attached to the trigger moves the sliding housing against the spring bias and opens or closes the clamp elements. A bag for the animal droppings is attached to each of the clamp elements such that the animal waste may be scraped from the ground and contained in the bag, which is then disposed in a sanitary manner.

U.S. Pat. No. 5,350,208 to Dante C. Heinrichson describes an animal waste pickup and disposal unit comprising a pair of opposed jaws each movable toward each other; a plastic bag removably disposed between the pair of jaws having material adjacent an open end thereof folded back over an outer surface of the pair of jaws. An arrangement disposed on the outer surface of each of the pair of jaws releasably secures the material of the bag to the outer surface of the pair of jaws. An elongated handle and another arrangement secured to each of the pair of jaws and the handle function to bias the pair of jaws in an open position and actuate each of the pair of jaws to enable picking up animal waste and depositing the same in the plastic bag for disposal at a later time,

U.S. Pat. 3,446,525 to Lawrence M. Jones describes a convenient sanitary portable pickup and transporting device for unclean material such as animal droppings. The device permits a user to grasp the material in a disposable wrapper means supported on the device for ready removal and replacement by a fresh wrapper means. In a preferred form, the wrapper is baglike and an inverted bag can be placed between open frame pickup members and the marginal portions of the bag turned over the bottom edges of the members. When the members are then moved together about a body of material to be collected, the material is retained in sealed condition within the bag and does not touch the members or other parts of the device. The bag being of compliant material thereby extends outwardly through the open frame members. The members are again moved apart to release the collected material. The disposable wrapper also is removed from the device without touching the portion which contacted the unclean material.

None of these prior art references describe the present invention.

### SUMMARY OF THE INVENTION

It is an object of the present invention to provide an animal waste collection device configured to provide consumers with an easy, hassle free means of collecting and discarding animal waste from an upright position and in a completely hands free manner.

The present invention includes a pet waste collection device for collecting and discarding pet waste. The pet waste collection device comprises an extendable support pole comprising a first pole portion having a first end and a second end and a second pole portion having a first end and a second end. The first end of the second pole portion is slidably receivable within the second end of the first pole portion. A securing mechanism releasably secures the first pole portion relative to the second pole portion. A catching component is mounted to the second end of the second pole portion with the catching component spring-biased into an open position. A switch mechanism is located at the first end of the first pole portion with the switch mechanism spring-biased toward the first pole portion. A cable connects the catching component to the switch mechanism. Upon pulling the switch mechanism in a general'direction away from the catching component, the catching component closes. Upon releasing the switch mechanism, the switch mechanism biases back toward the catching component and the catching component biases back to an open position.

In addition, the present invention is a method for collecting and discarding pet waste. The method comprises providing an extendable support pole comprising a first pole portion having a first end and a second end and a second pole portion having a first end and a second end, slidably inserting the first end of the second pole portion within the second end of the first pole portion, releasably securing the first pole portion relative to the second pole portion, mounting a catching component to the second end of the second pole portion, spring-biasing the catching component biased into an open position locating a switch mechanism at the first end of the first pole portion, spring-biasing the switch mechanism biased toward the first pole portion, connecting the catching component to the switch mechanism with a cable, pulling the switch mechanism in a general direction away from the catching component, closing the catching component, releasing the switch mechanism, biasing the switch mechanism back toward the catching component, and biasing the catching component back to an open position.

The present invention further includes a pet waste collection device for collecting and discarding pet waste. The pet waste collection device comprises an extendable support pole comprising a first pole portion having a first end and a second end and a second pole portion having a first end and a second end. The first end of the second pole portion is slidably receivable within the second end of the first pole portion. A securing mechanism releasably secures the first pole portion relative to the second pole portion. A catching component is mounted to the second end of the second pole portion with the catching component spring-biased into an open position. A handle is mounted to the first end of the first pole portion of the extendable support pole, beyond the switch mechanism. A switch mechanism is located at the first end of the first pole portion with the switch mechanism spring-biased toward the first pole portion. A cable connects the catching component to the switch mechanism. At least one pet waste bag is provided having an open end and a closed end with the pet waste bag positionable over the catching component, the opening of the pet waste bag positioned nearingly adjacent the second end of the second pole portion. Upon pulling the switch mechanism in a general direction away from the catching component, the catching component closes and the open end of the pet waste bag moves away from the second end of the second pole portion with the pet waste entering the pet waste bag. Upon releasing the switch mechanism, the switch mechanism biases back toward the catching component and the catching component biases back to an open position.

### BRIEF DESCRIPTION OF THE DRAWINGS

FIG. 1 is a sectional perspective view illustrating the pet waste collection device, constructed in accordance with the present invention, showing a handle in an extended state, a hook for hanging collection bags, an adjustable light fixture, a claw component for holding a pet and collecting waste, and a squeezable switch mechanism on the handle for operating the claw component.

FIG. 2 is another perspective view illustrating the pet waste collection device, constructed in accordance with the present invention, showing the handle in a retracted state, the hook for hanging collection bags, the adjustable light fixture the claw component for holding a pet and collecting waste, and the squeezable switch mechanism on the handle for operating the claw component.

FIG. 3 is a perspective view illustrating the pet waste collection device, constructed in accordance with the present invention, showing the handle in the extended state, the hook for hanging collection bags, the adjustable light fixture, the claw component for holding a pet and collecting waste, and the squeezable switch mechanism on the handle for operating the claw component.

FIG. 4 is an elevational side view of the pet waste collection device, constructed in accordance with the present invention showing the handle in the retracted state, the squeezable switch mechanism on the handle, the hook for hanging collection bags, and the adjustable light fixture.

FIGS. 5a and 5b are perspective views illustrating the pet waste collection device, constructed in accordance with the present invention, showing the attachment of the bag over the claws prior to and subsequent to collecting the pet waste.

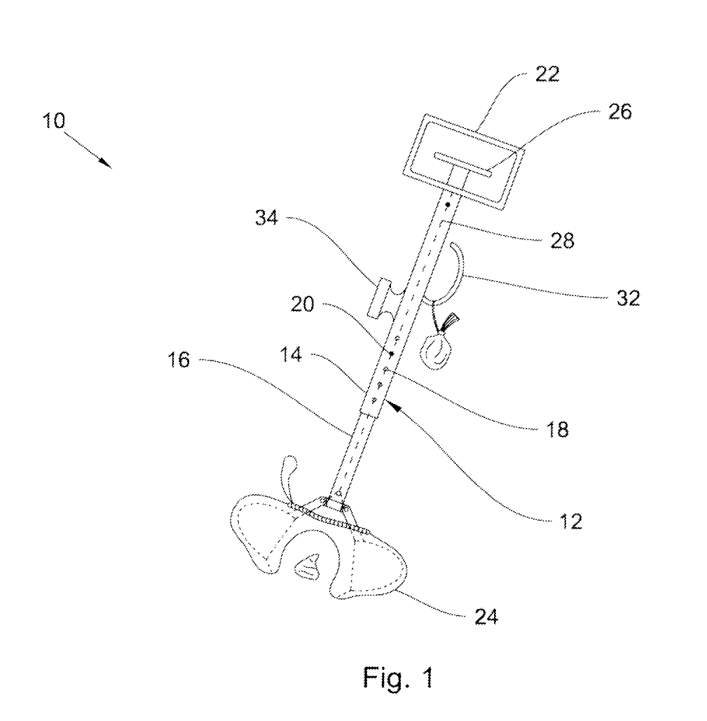

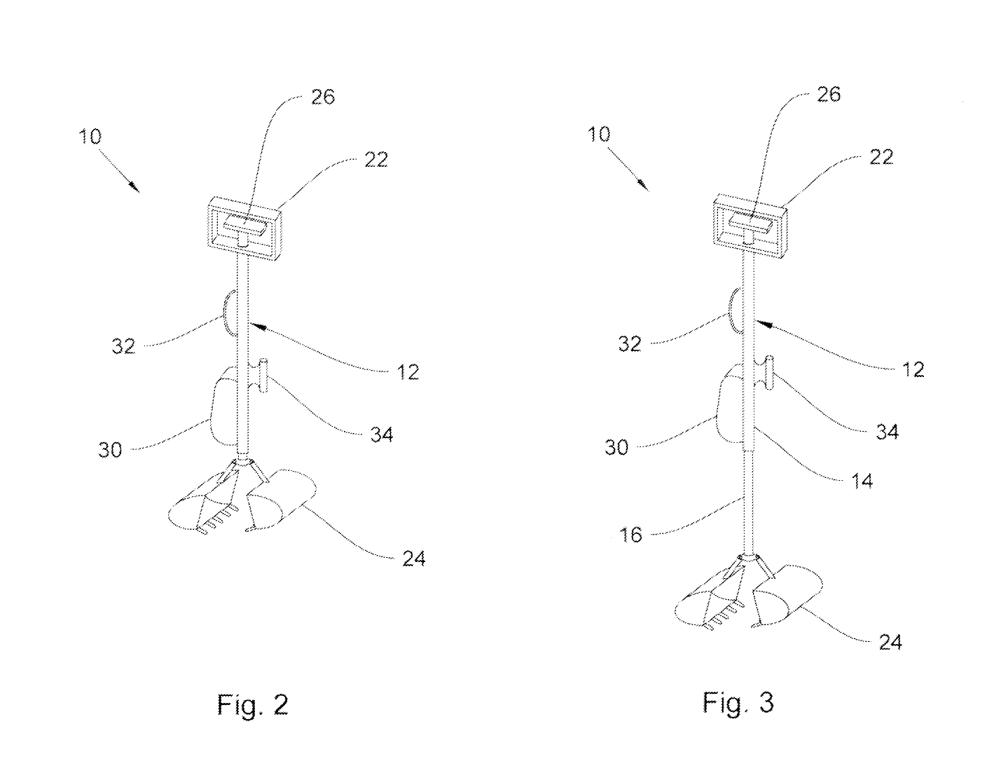

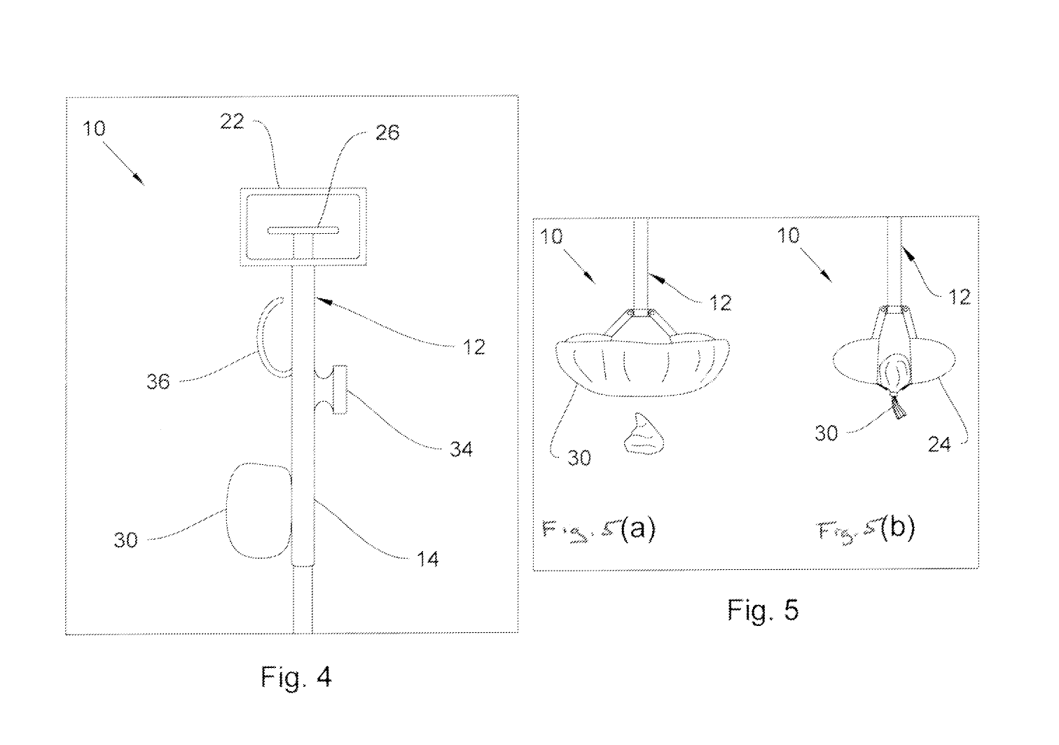

### DETAILED DESCRIPTION OF THE INVENTION

The present invention, hereinafter referred to as a Pet Waste Collection Device, indicated generally at 10, is an animal waste collection device configured to provide users with an easy, hassle free means of collecting and discarding animal waste from an upright position and in a completely hands free manner. The Pet Waste Collection Device 10 is preferably constructed from a lightweight and sturdy plastic material to facilitate easy transport and use.

The Pet Waste Collection Device 10 of the present invention includes an extendable support pole 10. The extendable support pole 10 has a first pole portion 12 having a first end and a second end and a second pole portion 14 having a first end and a second end. The first end of the second pole portion 16 is slidably receivable within the second end of the first pole portion 14 and releasably securable in a desired position. In this manner the length of the extendable support pole 12 can be lengthened or shortened depending on the desires and needs of the user.

The length of the extendable support pole 12 of the Pet Waste Collection Device 10 of the present invention is maintained by releasably securing the first pole portion 14 to the second pole portion 16 with a securing mechanism. In an embodiment of the present invention, the securing mechanism is a plurality of apertures 18 formed in the first pole portion 14 and a button 20 or the like formed on the second pole portion 16. The button 20 on the second pole portion 16, which can be, but not necessarily, spring-biased in a direction into the apertures 18 is releasably receivable within one of the apertures 18 thereby releasably securing the first pole portion 14 to the second pole portion 16 and maintaining the desired length of the extendable support pole 12.

The extendable support pole 12 of the Pet Waste Collection Device 10 of the present invention preferably measures approximately twenty two (22″) inches in a retracted length and thirty five (35″) inches in extended length, and one (1″) inch in circumference. Preferably, the second pole portion 16 can substantially and completely enter the first pole portion 14 providing the extendable support pole 12 with telescoping functionality, enabling the user to compact the Pet Waste Collection Device 10 when transporting or storing it.

In addition, the Pet Waste Collection Device 10 of the present invention includes a handle 22 mounted to the first end of the first pole portion 14 of the extendable support pole 12. Preferably, the handle 22 is ergonomically shaped and rubberized to facilitate a comfortable, secure grip.

Additionally, the Pet Waste Collection Device 10 of the present invention includes a catching component 24 mounted to the second end of the second pole portion 14. Preferably, the catching component 24 is spring-biased into an open position. Furthermore, preferably, the catching component 24 is an oval-shaped, claw-like component with a wide egress opening that can be opened and closed by a spring-loaded, squeezable switch mechanism 26 located at the first end of the first pole portion 14 and connected to the catching component 24 by a cable 28 or the like. The squeezable switch mechanism 26 dually functions to secure and release the catching component 24 such that as the switch mechanism 26 is moved in a general direction toward the handle 22 and away from the catching component 24 against the bias of the spring, the catching component 24 closes. As the switch mechanism 26 is released, the switch mechanism 26 is biased back toward the catching component 24 and the catching component 24 is biased to an open position, thereby opening the catch component 24.

Furthermore, the Pet Waste Collection Device 10 of the present invention includes plastic, resealable drawstring pet waste bags 30 positionable over the catching component 24. A single pet waste bag 30 is positionable over the catching component 24 with the opening of the pet waste bag 30 positioned nearingly adjacent the second end of the second pole portion 16. The catching component 24 is then centered over the pet waste and, as the squeezable switch mechanism 26 is manipulated to close the catching component 24, the open end of the pet waste bag 30 moves away from the second end of the second pole portion 16 with the pet waste entering the pet waste bag 30. The dosed catching component 24 isolates the pet waste in the pet waste bag 30. The user can then grab the pet waste bag 30 adjacent the open end and seal the pet waste bag 30 per normal. Conventional pet waste bags 30 can be used or disposable pet waste bags specifically constructed and manufactured for use with the Pet Waste Collection Device 10 can be used, as desired by the user.

The Pet Waste Collection Device 10 of the present invention further includes a hook mechanism 32 mounted to the first pole portion 14 suspending a pet waste bag collection so a fresh pet waste bag 30 is quickly accessible. Also, an adjustable light source 34 is mounted to the first pole portion 14 to illuminate both the owner and pets way after dark. Additionally, the Pet Waste Collection Device 10 is preferably provided in a variety of colors to appeal to individual tastes.

Using the Pet Waste Collection Device 10 of the present invention is simple and straightforward. A user adjusts the extendable support pole 12 to a desired length using a proximally located, pin lock button and then lines the catching component 24 with a plastic pet waste bag 30. Carrying the Pet Waste Collection Device 10 by its handle 22, the user walks their dog per usual routine. After the pet has eliminated its waste, the user compresses the switch mechanism 26 adjacent the handle 22 to open the catching component 24 at the second end of the second pole portion 16 of the present invention and conveniently collect the waste matter within the plastic pet waste bag 30. The user then draws the strings of the pet waste bag 30 closed or ties the open end in a knot, walks to the closest garbage receptacle, and releases the switch mechanism 26 to release the pet waste bag 30 for quick and easy disposal.

Using the catching component 24 and pet waste bag 30 combination of the Pet Waste Collection Device 10 enables a user to dispose of their pet's waste without n taking direct contact. The extendable support pole 12 enables a user to gather pet waste without having to bend over or stoop on their knees, important functionality for pet owners with limited mobility due to injury, arthritis knee problems, or back pain. Durably constructed of high quality material and components, the Pet Waste Collection Device 10 will withstand many years of continued use.

Although this invention has been described with respect to specific embodiments, it is not intended to e limited thereto and various modifications which will become apparent to the person of ordinary skill in the art are intended to fall within the spirit and scope of the invention as described herein taken in conjunction with the accompanying drawings and the appended claims.

1. A pet waste collection device for collecting and discarding pet waste, the pet waste collection device comprising:
an extendable support pole comprising:
a first pole portion having a first end and a second end; and
a second pole portion having a first end and a second end, the first end of the second pole portion is slidably receivable within the second end of the first pole portion;
a securing mechanism for releasably securing the first pole portion relative to the second pole portion;
a catching component mounted to the second end of the second pole portion, the catching component spring-biased into an open position;
a switch mechanism located at the first end of the first pole portion, the switch mechanism spring-biased toward the first pole portion; and
a cable connecting the catching component to the switch mechanism,
wherein upon pulling the switch mechanism in a general direction away from the catching component, the catching component closes and
wherein upon releasing the switch mechanism, the switch mechanism biases back toward the catching component and the catching component biases back to an open position.

2. The pet waste collection device of claim 1 wherein the securing mechanism is a plurality of apertures formed in the first pole portion and a button formed on the second pole portion, the button releasably receivable within one of the apertures thereby releasably securing the first pole portion to the second pole portion and maintaining the desired length of the extendable support pole.

3. The pet waste collection device of claim 1 wherein the second pole portion substantially and completely enters the first pole portion providing the extendable support pole with telescoping functionality.

4. The pet waste collection device of claim 1 and further comprising:
a handle mounted to the first end of the first pole portion of the extendable support pole, beyond the switch mechanism.

5. The pet waste collection device of claim 4 wherein the handle is ergonomically shaped and rubberized to facilitate a comfortable, secure grip.

6. The pet waste collection device of claim 1 wherein the catching component is an oval-shaped, claw-like component.

7. The pet waste collection device of claim 1 and further comprising:
at least one pet waste bag having an open end and a closed end
wherein the pet waste bag is positionable over the catching component, the opening of the pet waste bag positioned nearingly adjacent the second end of the second pole portion.

8. The pet waste collection device of claim 7 wherein upon the centering the catching component the pet waste and, as the switch mechanism is manipulated to close the catching component, the open end of the pet waste bag moves away from the second end of the second pole portion with the pet waste entering the pet waste bag.

9. The pet waste collection device of claim 1 and further comprising:
a hook mechanism mounted to the first pole portion.

10. The pet waste collection device of claim 1 and further comprising
an adjustable light source mounted to the first pole portion.

11. A method for collecting and discarding pet waste, the method comprising:
providing an extendable support pole comprising:
a first pole portion having a first end and a second end; and
a second pole portion having a first end and a second end;
slidably inserting the first end of the second pole portion within the second end of the first pole portion;
releasably securing the first pole portion relative to the second pole portion:
mounting a catching component to the second end of the second pole portion:
spring-biasing the catching component biased into an open position;
locating a switch mechanism at the first end of the first pole portion;
spring-biasing the switch mechanism biased toward the first pole portion;
connecting the catching component to the switch mechanism with a cable;
pulling the switch mechanism in a general direction away from the catching component;
closing the catching component;
releasing the switch mechanism;
biasing the switch mechanism back toward the catching component; and
biasing the catching component back to an open position.

12. A pet waste collection device for collecting and discarding pet waste, the pet waste collection device comprising:
an extendable support pole comprising:
a first pole portion having a first end and a second end; and
a second pole portion having a first end and a second end, the first end of the second pole portion is slidably receivable within the second end of the first pole portion;
a securing mechanism for releasably securing the first pole portion relative to the second pole portion:
a catching component mounted to the second end of the second pole portion, the catching component spring-biased into an open position;
a handle mounted to the first end of the first pole portion of the extendable support pole, beyond the switch mechanism;
a switch mechanism located at the first end of the first pole portion, the switch mechanism spring-biased toward the first pole portion;
a cable connecting the catching component to the switch mechanism;
at least one pet waste bag having an open end and a closed end;
wherein the pet waste bag is positionable over the catching component, the opening of the pet waste bag positioned nearingly adjacent the second end of the second pole portion;
wherein upon pulling the switch mechanism in a general direction away from the catching component, the catching component closes and the open end of the pet waste bag moves away from the second end of the second pole portion with the pet waste entering the pet waste bag; and
wherein upon releasing the switch mechanism, the switch mechanism biases hack toward the catching component and the catching component biases back to an open position.

13. The pet waste collection device of claim 12 wherein the securing mechanism is a plurality of apertures formed in the first pole portion and a button formed on the second pole portion, the button releasably receivable within one of the apertures thereby releasably securing the first pole portion to the second pole portion and maintaining the desired length of the extendable support pole.

14. The pet waste collection device of claim 12 wherein the second pole portion substantially and completely enters the first pole portion providing the extendable support pole with telescoping functionality.

15. The pet waste collection device of claim 12 wherein the handle is ergonomically shaped and rubberized to facilitate a comfortable, secure grip.

16. The pet waste collection device of claim 12 wherein the catching component is an oval-shaped, claw-like component.

17. The pet waste collection device of claim 12 and further comprising:
a hook mechanism mounted to the first pole portion.

18. The pet waste collection device of claim 12 and further comprising:
an adjustable light source mounted to the first pole portion.
